(19) United States
(12) Patent Application Publication
(10) Pub. No.: US 2006/0193078 A1
(43) Pub. Date: Aug. 31, 2006

(54) Data storage libraries

(75) Inventors: Brian Hext, Wells (GB); Charles Donkin, Wells (GB)

Correspondence Address: BACON & THOMAS, PLLC, 625 SLATERS LANE, FOURTH FLOOR, ALEXANDRIA, VA, 22314, US

(73) Assignee: M5 Data Limited, Wells (GB)

(21) Appl. No.: 11/358,059

(22) Filed: Feb. 22, 2006

(30) Foreign Application Priority Data
Feb. 26, 2005 (GB) 0504032.4

(51) Int. Cl. G11B 15/68

(52) U.S. Cl. 360/92

(57) ABSTRACT

A data storage library for the storage of a plurality of data storage media, the library including a Z-direction mechanism for raising and lowering the media within the library, the Z-direction mechanism comprising support means for a picker mechanism for inserting storage media into and withdrawing them from storage locations within the library, a motor driven rotateable lever arranged to raise and lower the picker mechanism, and a counter-balancing mechanism including a spring which serves to reduce the power required to drive the motor.

### BACKGROUND TO THE INVENTION

This invention concerns data storage libraries in which a plurality of individual data storage media can be stored at various positions within the libraries.

So-called libraries in which data is stored in magnetic or optical form on a plurality of individual data storage media are well known in the art. Particular data storage media which have been used include magnetic tape cartridges and cassettes, tape spools, magnetic storage discs, and data stored in optically readable form, for example on a storage disc.

In general, such libraries store the media in racks, drums or magazines, or on shelves, from which individual media can be extracted by a transport mechanism which conveys them to a data drive where data is read from or written to them, to other positions within the library, or even to another library.

Unlike conventional libraries for housing books, which fill rooms, magnetic and optical storage media for libraries of the type described are frequently stored in units which are of a size such that they fit within standard 19 inch (approximately 483 mm) racking systems, software residing on a separate computer or computers being used to control the functioning of these units. In addition, space constraints usually dictate that these units also have as small a height as possible based on increments of 1.75 inches (44.45 mm), which is generally the standard height increment for racking systems. There is therefore a desire for storage units which are to be housed within such racking systems to provide storage space for as many individual storage media as possible but also in the smallest rack height possible.

In addition to storing the data storage media themselves, such storage units also need to house a transport mechanism for transporting individual media within the units, or to another unit, and in general they also have to house data drives for reading from and/or writing to individual data storage media, plus a power supply for the unit.

Yet further equipment is usually included within these units, for example cooling fans and devices for identifying individual media within them, e.g. bar code readers for reading bar codes on the individual media, so that the transport mechanism can select and move the correct medium. This is clearly essential if the individual storage media are arbitrarily loaded by hand into vacant positions within the unit, and it is highly desirable even where this is not the case in order that control of the positioning and movement of the media within the units can be satisfactorily monitored. This can be particularly desirable where media can be exchanged between adjacent units.

Bearing in mind the physical requirements of equipment required within each unit, for example power supplies, read/write devices for the stored media and transport mechanisms for transporting the media within the units, plus the overall physical constraints of the storage units themselves, the space within the units which is available to store individual data storage media is itself restricted. Furthermore, the physical dimensions of the data storage media themselves, their individual orientations within the units, for example imposed by racking systems, and the need to insert them into and remove them from individual storage locations within the units, impose constraints as to how many data storage units can be stored in a particular size of unit.

In general, data storage media used in libraries of the type in question have one dimension which is substantially less than the other two, thereby enabling them to be stored with this minimum dimension either vertical or horizontal, the media themselves then being described as being stored either horizontally or vertically, respectively.

Both horizontal and vertical storage of data storage media has been used hitherto in an attempt to maximise the number of storage units which can be stored within a particular unit. Storage with the media arranged vertically, that is with their minimum dimension arranged horizontally, has the advantage that individual storage media can be inserted into and removed from storage locations within a library using a transport mechanism operating solely within the X-dimension within the library, that is from front to back of the library. Picking and insertion of individual media from and to their respective storage locations can then be effected without the need for Z-direction movement of the picking mechanism, that is vertically. However, if the data storage media are stored in pluralities of horizontal stacks, that is with their minimum dimension vertical, or if more than one layer of vertically arranged media is housed within a unit, the transport mechanism also has to operate in the Z-direction.

Various transport mechanisms have been proposed hitherto for providing movement of the mechanism in the Z-direction in data storage libraries, and typically such mechanisms involve the use of drive belts driven by stepping or DC motors. Although satisfactory Z-direction movement can be achieved using such mechanisms, they frequently occupy additional space in the X- and Y-directions within the units compared with mechanisms which only provide movement in the X- and Y-directions. This is a disadvantage because of space limitations within the units caused by the overall physical dimensions of the units themselves and those of the non-storage components such as power supplies and data readers/writers which have to be housed within the units.

Withdrawal and insertion of data storage media from and into their respective storage locations is generally effected using a picker mechanism which can both translate and rotate the media in a horizontal plane, that is provide both R- and θ-movement. These movements are required, for example, to access data readers/writers placed at 90° to the media storage locations, and to access further storage locations facing the original array. X-Direction movement of the picker mechanism itself within the library unit can thereby be avoided, and as a result the associated space for this movement by the picker mechanism can be avoided.

### SUMMARY OF THE INVENTION

According to the present invention there is provided a data storage library for the storage of a plurality of data storage media, the library including a Z-direction mechanism for raising and lowering the media within the library, the Z-direction mechanism comprising support means for a picker mechanism for inserting storage media into and withdrawing them from storage locations within the library, a motor driven rotateable lever arranged to raise and lower the picker mechanism, and a counter-balancing mechanism including a spring which serves to reduce the power required to drive the motor.

### BRIEF DESCRIPTION OF THE DRAWINGS

An embodiment of transport mechanism for data storage media in data storage libraries in accordance with the present invention will now be described with reference to the accompanying drawings in which:

FIG. 1 is a perspective view of the embodiment;

FIG. 2 is a plan view of the embodiment;

FIG. 3 is a side view of the embodiment;

FIG. 4 is a perspective view of a part of the embodiment;

FIG. 5 is a plan view of the part of the embodiment shown in FIG. 4;

FIG. 6 is a side view of part of the embodiment shown in FIGS. 1-3 with parts removed;

FIG. 7 is a plan view of the part of the embodiment shown in FIG. 4 with parts removed for clarity;

FIG. 8 is a perspective view of the embodiment seen in the direction of arrow A in FIG. 4;

FIG. 9 is a perspective view of the embodiment seen in the direction of arrow B in FIG. 4;

FIG. 10 is a perspective view to an enlarged scale of part of the embodiment shown in FIGS. 4-8;

FIGS. 11a-e are side views of part of the embodiment with parts omitted for clarity; and

FIGS. 12a-e are perspective views corresponding to FIGS. 11a-e.

The illustrated transport mechanism can be used in a variety of data storage libraries and so only the mechanism is shown in the drawings.

### DETAILED DESCRIPTION OF THE PREFERRED EMBODIMENTS

The mechanism shown consists of a substantially horizontal and rectangular platform 1 carrying a picker mechanism 2 which is movable relative to the platform 1 to provide movement of the picker mechanism 2 in the Y-direction, and a vertical motion mechanism 3 for moving the platform 1 up and down to provide the picker mechanism 2 with movement in the Z-direction within the library. The picker mechanism 2 also provides translation of data storage media in the R-direction and angular rotation θ of the data storage media in the X,Y-plane.

The platform 1 consists of a framework with two long sides 4 and 4′ connected together by two short sides 5 and 5′. Two pairs of rollers 6 and 6′, one roller of each pair being disposed above the other, are respectively located in vertical guides 7 and 7′ which are both of channel section. The guides 7 and 7′ are secured within the unit to prevent them moving when the mechanism is operated.

A rod 8 is pivotally mounted in holes in end portions 9 and 9′ respectively of the shorter sides 5 and 5′ of the platform 1. Pinions 10 and 10′ are fast on the respective ends of the rod 8, and they engage vertical rack strips 11 and 11′ respectively attached to the vertical guides 7 and 7′ respectively. A guide roller 12 is pivotally mounted on shorter side 5′ of the platform 1 serve to reduce front to back translation of the platform 1.

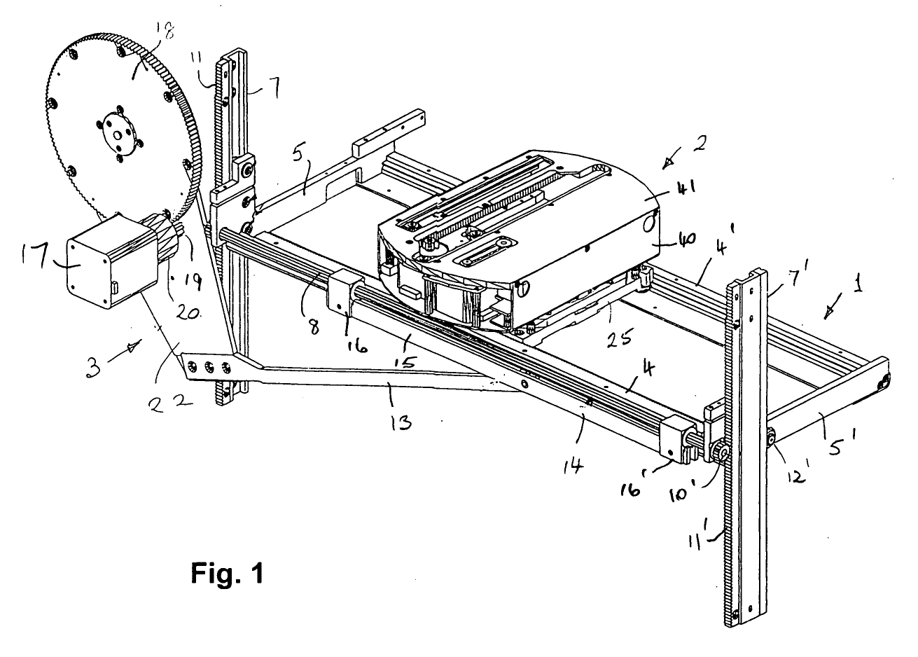

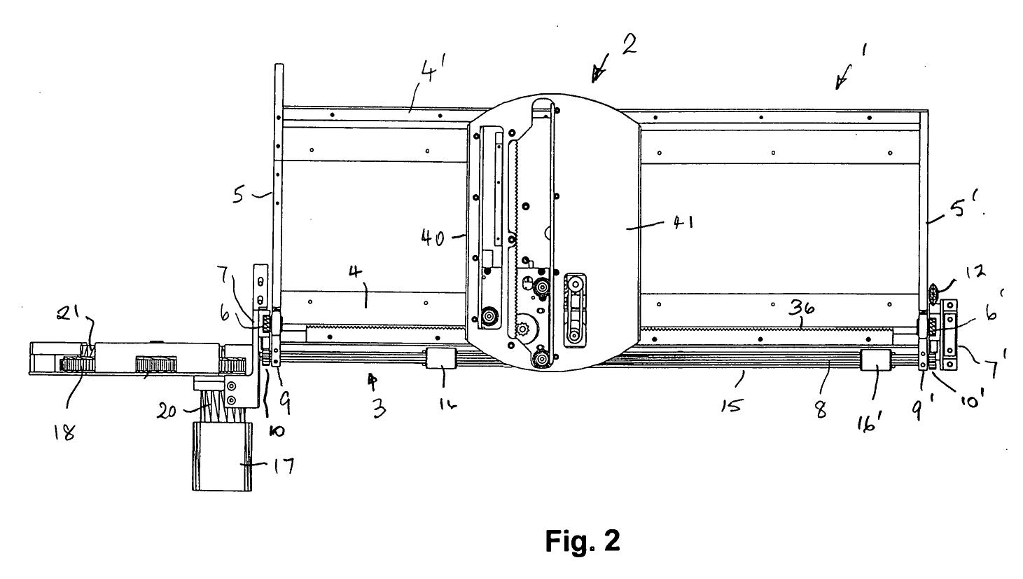

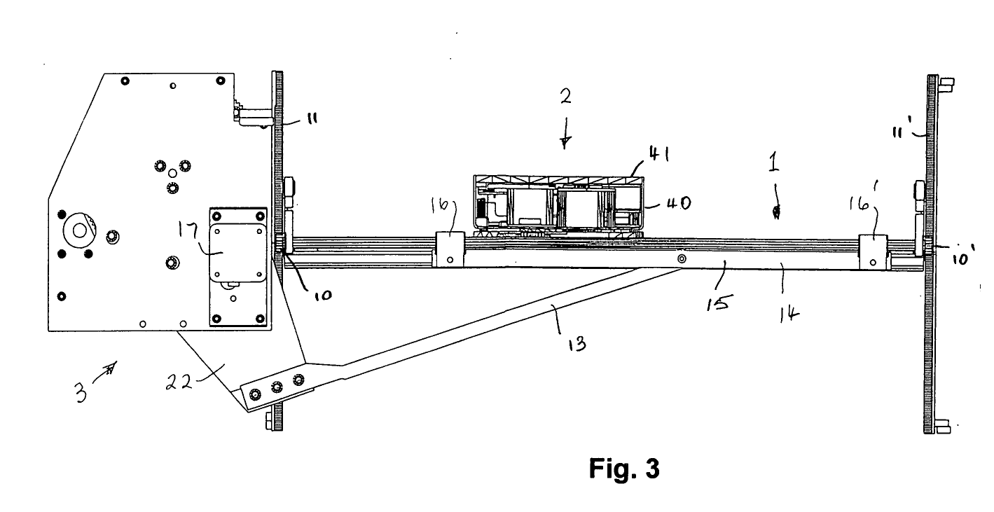

The vertical motion mechanism 3 includes an arm 13 which is rotateable in a vertical plane beneath the rod 8, and is pivotally connected to the rod 8 by a slider mechanism 14. As can be seen from FIGS. 1 and 2, the slider mechanism 14 consists of a pair of substantially horizontal strips 15 between which, and at a central region thereof, is pivoted an end portion of the arm 13. Sliders 16 and 16′ are attached to end portions of the strips 15 and are slideable on the rod 8 which is also free to rotate within the sliders 16 and 16′.

Arm 13 is connected to a gear wheel 18 by an extension piece 22, the gear wheel 18 being mounted on a shaft which is rotateable in a suitable hole in the framework of the unit. The gear wheel 18 is dished for reasons which will subsequently be explained.

An electric motor 17 attached to the framework of the library (not shown) drives the gear wheel 18 via a pinion 19 on the output shaft of a speed reducing gearbox 20 driven by the output shaft of the motor 17. A “clock” spring 21 is positioned within the dish of the gear wheel 18, and it is secured at its outer end 23 to the framework of the library and at its inner end 24 to hub 26 the gear wheel 18, the spring 21 having been pre-wound to provide an upward force which substantially balances the combined downwardly acting weight of the platform 1, the picker mechanism 2, the arm 13 and the extension piece 22. As a result, the electrical power required by the motor 17 to raise and lower the platform 1 with its picker mechanism 2 is relatively low, and so a much smaller motor is required than if it had in particular to raise the platform 1 without this assistance. Not only does this have the advantage of being able to use a lower powered electric motor, which inherently tend to be relatively small, the use of a “clock” spring enables substantial lifting forces to be provided within a relatively small footprint within data storage libraries. Indeed, the “clock” spring can be substantially contained within the thickness of the dished gear wheel 18.

By the term “clock” spring we mean a spring made from a strip of metal which is wound in successive turns with one turn on another. Such springs are also known as “power” springs.

Coil springs are generally not preferred because in order to produce an effect similar to that of a “clock” spring they would, by contrast, have to be substantially larger, and they are unlikely to fit into the space required by a “clock” spring producing the same or similar lifting effect.

Actuation of the motor 17 causes the pinion 19 to rotate, which rotates the gear wheel 18 which in turn rotates the extension piece 22 and the arm 13, thereby partially winding or unwinding the pre-wound spring 21. The slider mechanism 14 is also raised or lowered, and the sliders 16 and 16′ slide along the rod 8 as the latter and the platform 1 to which it is attached are also raised or lowered.

Control of raising and lowering of the platform 1 can be effected in any convenient manner, for example using a magnetically or optically coded strip attached to either of the fixed vertical guides 7 and 7′, and an associated magnetic or optical detector on the platform 1 (neither being shown in the drawings).

As can be seen from FIG. 2, the mechanism 3 can be made to occupy relatively little space within the library unit within which it is located, the arm 13 being positioned directly below the rod 8. The use of a dished gear wheel, which can itself be relatively thin, and a “clock” spring within it, which can also be relatively narrow whilst providing a strong rotational force, also contributes to the small space required by the mechanism 3. The motor 17 and its associated gear box 20 do project out of the plane of operation of the arm 13, but they can be relatively small because the motor 17 does not have to move the whole weight of the platform 1 and the picker mechanism 2 to move the latter in the Z-direction.

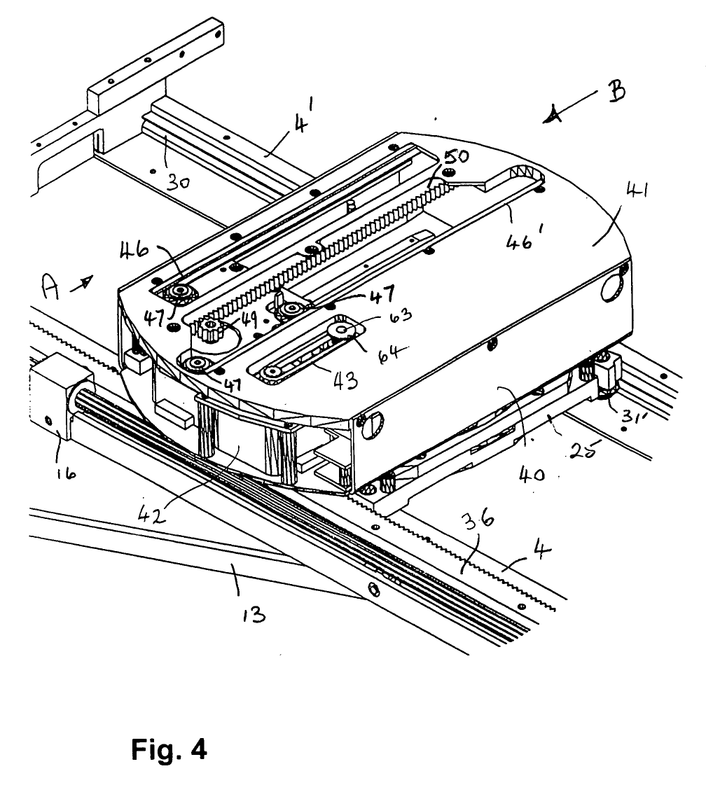

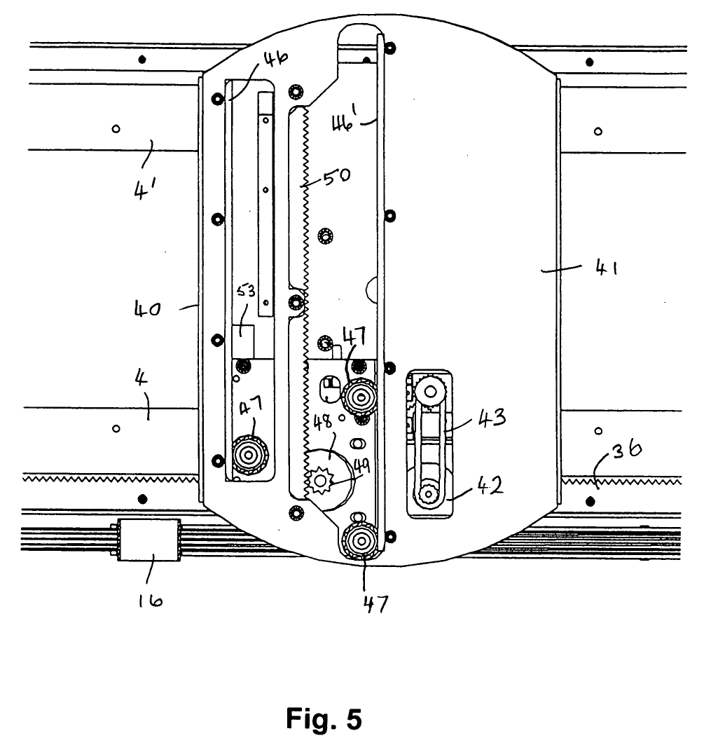

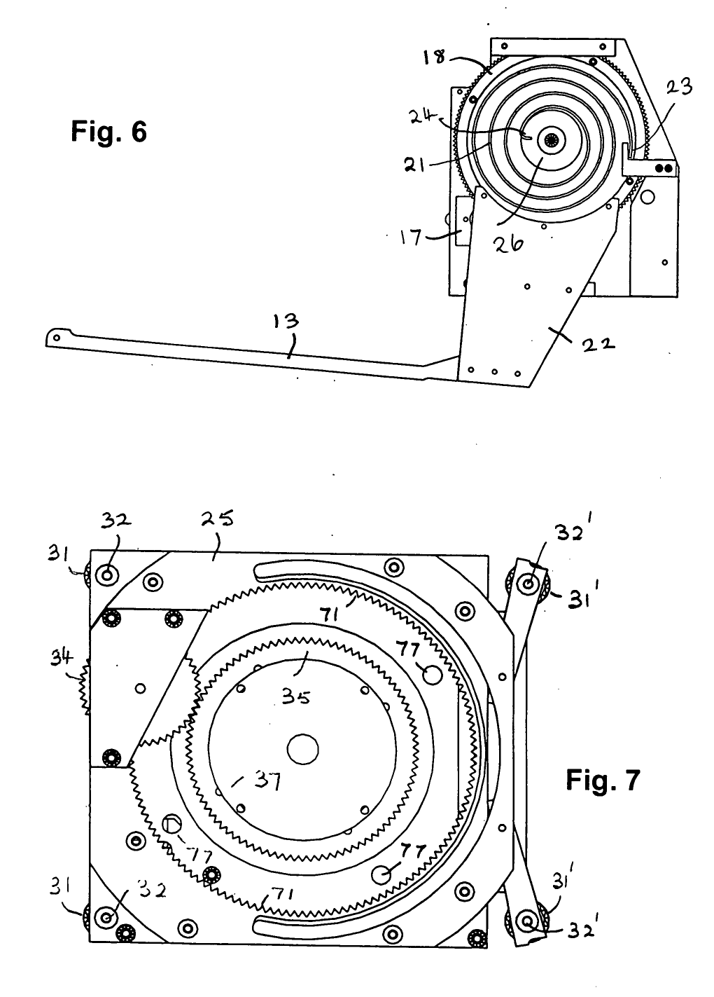

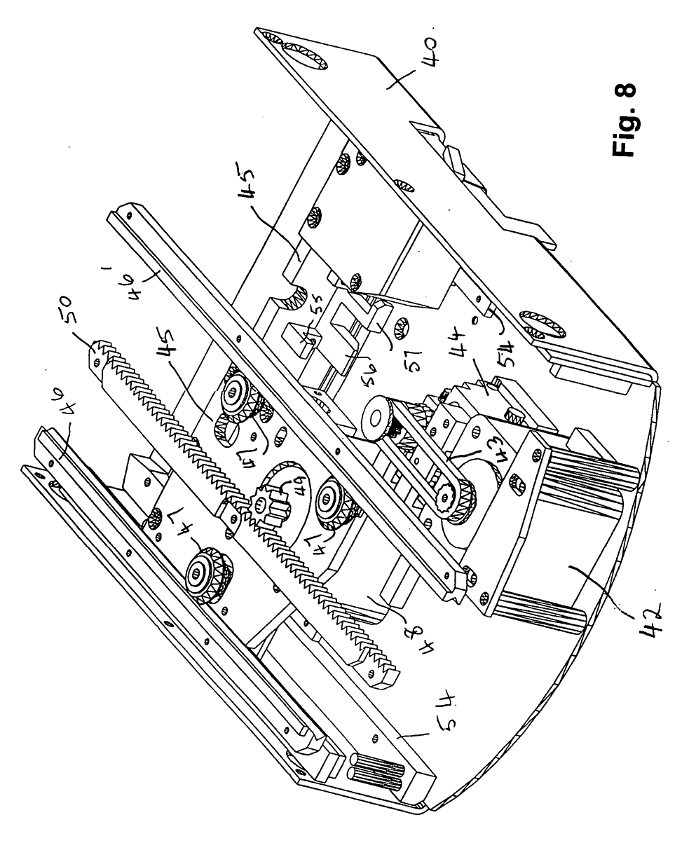

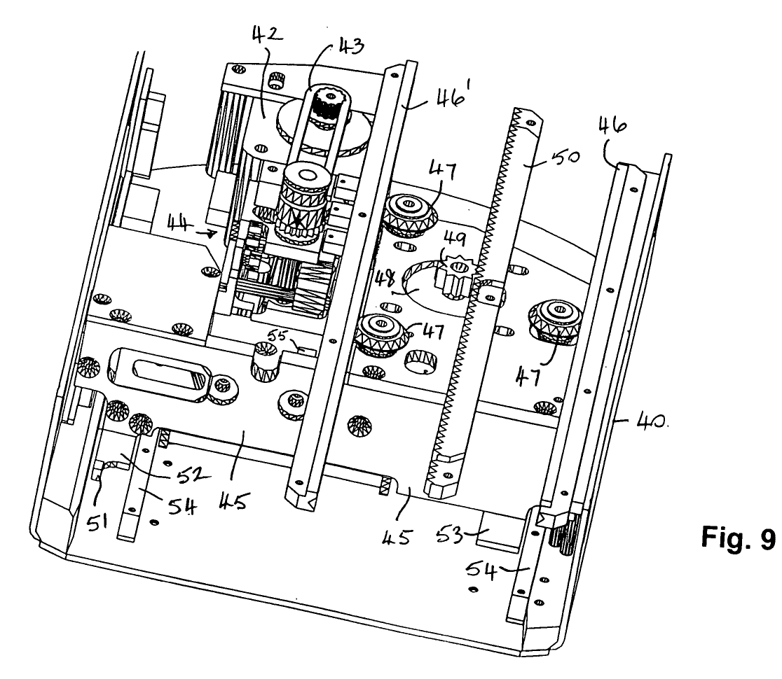

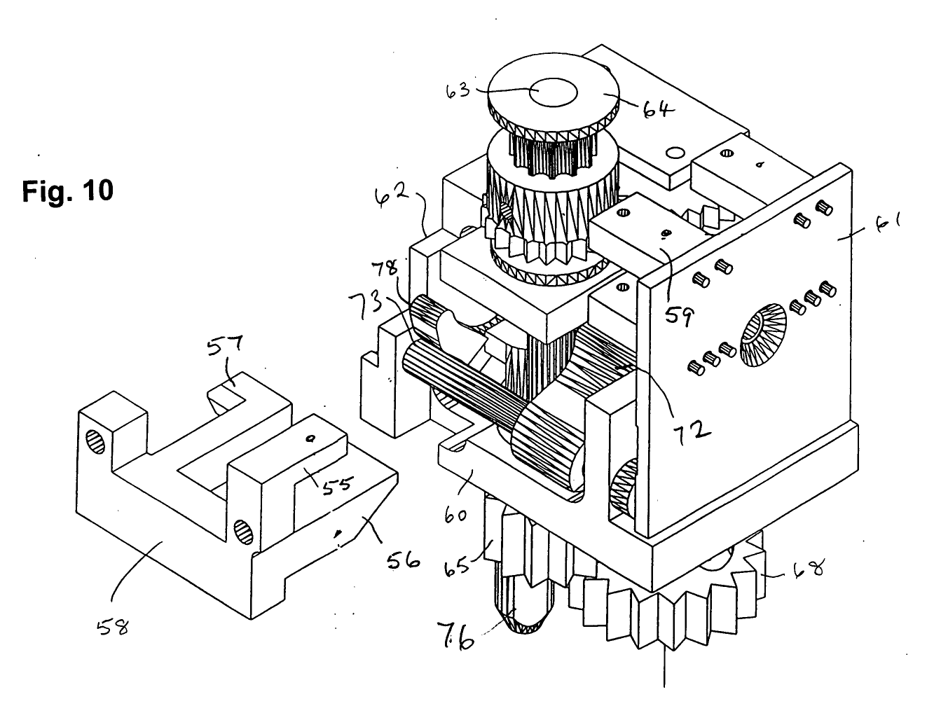

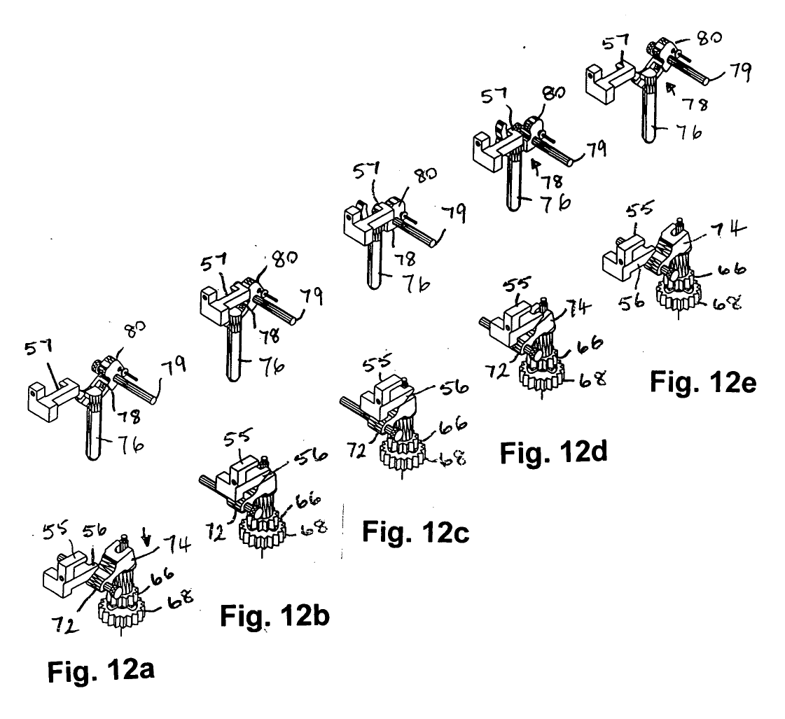

The picker mechanism 2 will now be described with reference to FIGS. 4-12.

The picker mechanism 2 consists of a base plate 25 on which is pivotally mounted a substantially “U” section body portion 40 with a lid 41 attached thereto. As can be seen more clearly from FIG. 7, the base plate 25 has two pairs of wheels 31 and 31′ which run in grooves 30 extending down the lengths of the long sides 4 and 4′ respectively of the platform 1. Shafts for the wheels 31 rotate in bearings 32 mounted in the base plate 25, and shafts for the wheels 31′ rotate in bearings 32′ mounted in end portions of arms 33 which are biased by springs (not shown) into the grooves 30, thereby locating the base plate 25 on the platform 1.

The base plate 25, and therefore the body portion of the picker 2, is movable along the grooves 30 in the sides 4 and 4′ using a motor 42 through a belt drive 43 and a gear box shown generally at 44. A gear wheel 34 driven by a gear wheel 35 driven from the gear box 44 meshes with a straight rack strip 36 attached to the long side 4 of the platform 1.

The gear wheel 35 is rotateable on a large diameter bearing 37 about which the body portion 41 is also rotateable. The large diameter bearing 37 provides space for cables to pass through it for control of the picker mechanism 2.

Within the body portion 40 is a gear box actuator mechanism 45 which is slideable within the body portion 40 on grooved tracks 46, 46′ attached to the lid 41 of the picker 2, the actuator mechanism 45 having three wheels 47 which run in the grooved tracks 46 and 46′.

Movement of the actuator mechanism 45 along the tracks 46, 46′ is effected using a motor 48 with a pinion 49 on its output shaft, the pinion 49 engaging a rack strip 50 attached to the underside of the lid 41. Power to operate the motor 48 is provided via a ribbon cable (not shown).

Integral with the actuator mechanism 45 is a cartridge picker 51 which is shaped to engage a recess in the underside of standard data storage cartridges. Engagement of the picker 51 with the recess in the underside of a standard cartridge can then be effected by lowering the platform 1 and moving the actuator mechanism 45 away from the gear box 44 so that the picker 51 projects out of the body portion 41 and beneath the cartridge so that the picker 51 is located beneath the aperture in the cartridge. The platform 1 is then raised so that the picker 51 enters the aperture in the cartridge. The cartridge is then supported by two cartridge levellers 52 and 53, the leveller 52 including the picker 51.

Removal of the cartridge from its storage location within the library is then effected by moving the actuator mechanism 45 back into the body portion 40, the cartridge being pulled over support runners 54 attached to the body portion 40.

A probe 55 and actuator members 56 and 57 form part of a gearbox actuator 58 attached to the actuator mechanism 45 on the opposite side from the levellers 52 and 53. The actuator members 56 and 57 serve to actuate the gear box 44 when a cartridge is drawn sufficiently far along the runners 54 into the body portion 40. The probe 55 co-operates with a sensor 59 to detect when the actuator members 56 and 57 have entered the gear box 44 sufficiently to actuate the dog-clutch, and also when they have moved out of the gear box 44 sufficiently for the dog clutch to have disengaged.

The gear box 44 has a horizontal base plate 60 with two vertical side plates 61 and 62 within which is located a vertical input shaft 63 with a pulley 64 fast on its upper end, the pulley 64 being driven by the drive belt 43. A gear wheel 65 fast on the lower end of the shaft 63 meshes with a gear wheel 66 on a vertical rotateable shaft 67, the gear wheel 66 being slideable on the shaft 67. A further gear wheel 68 is fast on the shaft 67.

The gear wheel 66 has dog-clutch teeth 69 between it and the gear wheel 68, and the gear wheel 68 has recesses in it to receive the teeth of the dog-clutch when the latter is engaged. A compression spring 70 between the gear wheels 66 and 68 serves to push the two halves of the dog-clutch apart and out of engagement with each other.

The gear wheel 65 is permanently meshed with the gear wheel 66, the gear wheel 66 also being permanently meshed with the gear wheel 35.

The gear wheel 68 is permanently meshed with a toothed rack ring 71 secured to the base 25 of the picker 2.

Operation of the dog-clutch is effected by the actuator member 56 which on being pushed into the gear box 44 engages a cam 72 mounted on a horizontal shaft 73 which is rotateable in the side plates 61 and 62 of the gear box 44. The cam 72 has a forked end portion 74 which is disposed around an upper portion of the shaft 67. The forked end portion 74 of the cam 72 rests on the upper surface of an upward extension 75 of the gear wheel 68. Insertion of the actuator member 56 into the gear box pushes the cam 72 down, which in turn pushes the gear wheel 68 down, thereby engaging the dog-clutch. Rotation of the shaft 63 then causes the gear wheel 68 to rotate, thereby causing the picker body 40 to rotate about the shaft 36.

Withdrawing the actuator member 56 from the gear box 44 allows the cam 72 to rotate upwardly as a result of the upward force provided by the compression spring 70 between the gear wheels 66 and 68, and the dog-clutch as a result disengages and rotation of the picker body 40 ceases.

A slideable pin 76 extends downwardly from the gear box 44, a lower end portion of the pin 76 engaging holes 77 in the base plate 25 to lock the picker body 40 in rotational positions 90° relative to each other.

The pin 76 can be withdrawn from the holes 77 by actuating a substantially “L” shaped lever 78 which is pivotal about a shaft 79. A projection on the lever 78 engages a slot in an upper end portion of the pin 76, rotation of the lever 78 thereby serving to raise or lower the pin 76.

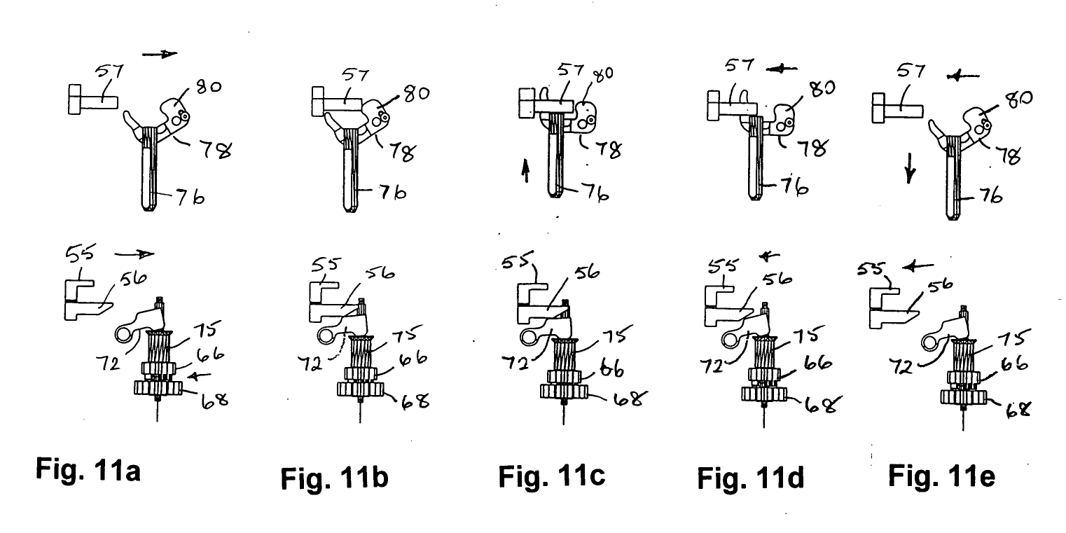

The various stages of insertion and withdrawal of the actuator mechanism 58 into the gear box 44 can be seen from FIGS. 11a-e and 12a-e.

Normally, without insertion of the actuator member 57, the pin 76 will be located in one of the holes 77. However, insertion of the actuator 58 into the gear box 44 results in the actuator member 57 pushing against an extension 80 of the lever 78, thereby causing the latter to rotate and lift the pin 76 out of the hole 77 in which it was located. This, of course, is necessary to enable the body 41 of the picker 2 to rotate when the dog-clutch described above is engaged.

When the actuator member 57 is withdrawn from the gear box 44, the lever 78 rotates, and the pin 76 can then enter one of the holes 77.

When the actuator 58 is withdrawn from the gear box 44, rotation of the shaft 63 results in gear wheel 65 rotating gear wheels 35 and 34, the latter moving along the straight rack strip 36. The result is movement of the picker 2 in the plane of the platform 1.

The ratios of the numbers of teeth on the gear wheels 35, 66 and 65, and on the toothed ring 71, are such that if the toothed ring 71 is rotated, the gear wheel 35 remains static. This enables the body portion 40 of the picker mechanism 2 to rotate relative to the base plate 25 whilst the picker mechanism 2 remains stationary relative to the rack strip 36.

Insertion of the pin 76 into one of the holes 77 in the base plate 25 serves to prevent movement of the base plate in the Y-direction whilst the body portion 40 is being rotated relative to the base plate 25.

Movement of the picker 2 is effected using a single motor, thereby enabling the picker 2 to be made relatively compact compared with pickers using separate drive motors for Y- and θ-direction movement. Furthermore, movement of the individual data storage media into and out of the picker 2 activates the gear box 44 and as a result automatically changes between these directions of movement.

As will be appreciated, vertical motion mechanisms in accordance with the present invention could be used with any of a variety of picker mechanisms to provide motion in the Z-direction, and not necessarily that shown in the accompanying drawings.

It will also be appreciated that picker mechanisms in accordance with the present invention could be used in a variety of data storage libraries, including those which do not include mechanisms in accordance with the present invention for providing Z-direction movement.

What is claimed:

1. A data storage library for the storage of a plurality of data storage media, the library including a Z-direction mechanism for raising and lowering the media within the library, the Z-direction mechanism comprising support means for a picker mechanism for inserting storage media into and withdrawing them from storage locations within the library, a motor driven rotateable lever arranged to raise and lower the picker mechanism, and a counter-balancing mechanism including a spring which serves to reduce the power required to drive the motor.

2. A data storage library according to claim 1, wherein the spring is a “clock” spring.

3. A data storage library according to claim 1, wherein the spring mechanism includes a gear wheel driven by said motor.

4. A data storage library according to claim 3, wherein the gear wheel has a recess therein in which is disposed the spring of the spring mechanism.

5. A data storage library according to claim 1, wherein the motor driven rotatable lever is slides relative to the support mechanism for the picker mechanism when the motor is actuated and the support mechanism is raised or lowered.

6. A data storage library according to claim 1, wherein the motor driven rotateable lever and the counter-balancing mechanism are substantially in the same vertical plane.

7. A data storage library according to claim 1, which includes an array of storage locations for data storage media, said locations being arranged vertically relative to each other, the Z-direction mechanism being operable to insert and remove data storage media into and from storage locations at different vertically disposed levels within the array.

8. A data storage library according to claim 1, wherein movement of the support means in the Z-direction enables the picker mechanism to engage with or withdraw from engagement with data storage media within the library.

9. A data storage library according to claim 1, including means for reading data from data storage media within the library.

10. A data storage library according to claim 1, including means for writing data to the data storage media within the library.

11. A data storage library according to claim 1, including a picker for picking data storage media from and inserting the media into storage locations within the library, the picker having a single motor for effecting both movement of the picker in the Y-direction and changing the θ-orientation of the media within the library.

12. A data storage library according to claim 11, wherein movement of the picker in the Y-direction and changing the θ-orientation of the media within the library is effected via a gear box.

13. A data storage library according to claim 11, wherein movement of the picker in the Y-direction and changing the θ-orientation of the media within the library are selected by actuator means which in use operates a gear box to select the required motion.

14. A data storage library according to claim 1, wherein loading and unloading of data storage media onto and from the picker is effected using a further motor.

15. A data storage library according to claim 1, wherein the picker mechanism is prevented from rotating whilst it is being moved in the Y-direction within the library.

16. A data storage library according to claim 1, wherein selection of Y-direction movement and θ-orientation of the media within the library is effected using a dog clutch to select θ-orientation of the media.
